(19) United States
(12) Patent Application Publication
(10) Pub. No.: US 2007/0200785 A1
(43) Pub. Date: Aug. 30, 2007

(54) Satellite antenna cover

(76) Inventor: Michael J. Courtney, Marina Del Rey, CA (US)

Correspondence Address: CISLO & THOMAS, LLP, 233 WILSHIRE BLVD, SUITE 900, SANTA MONICA, CA, 90401-1211, US

(21) Appl. No.: 11/595,252

(22) Filed: Nov. 10, 2006

Related U.S. Application Data
(63) Continuation of application No. 10/982,671, filed on Nov. 4, 2004, now Pat. No. 7,161,553.

(51) Int. Cl. H01Q 1/42

(52) U.S. Cl. 343/872

(57) ABSTRACT

A satellite antenna cover includes a substantially rigid and concave surface configured to permit the reception and transmission of satellite communication signals, a curved outer rim emanating there from, and at least one secure antenna attachment member integrally formed on the outer rim. The antenna attachment member includes a body configured substantially as a raised bridge, and at least one elongated and resilient tab extending away from the raised bridge-like body.

### CROSS-REFERENCE TO RELATED APPLICATIONS

This utility patent application is a continuation of pending U.S. Utility patent application Ser. No. 10/982,671, filed on Nov. 4, 2004 and published on May 4, 2006 under US 2006/0092089 A1, the disclosure of which is incorporated herein in its entirety by reference.

### BACKGROUND

When rain or snow collects in the bottom portion of an uncovered satellite dish of a standard parabolic configuration, the moisture content scatters the broadcast signal and prevents it from focusing properly on the feed horn. When enough of a TV broadcast signal is scattered, the picture is lost on the TV set. After a heavy snowfall, the sheer weight of the snow pulls the aim of the dish down below the satellite arc resulting in compromised picture quality for the user. Repeated heavy snowfall or hail may lead to perforation of the satellite dish, reducing the accuracy of the signal-receiving (reflective) surface. In some satellite dish antennas, the added weight of snow puts unnecessary stress on the actuator and motor which causes premature failure of either or both.

On clear days, a certain amount of the sun's heat and UV (Ultra Violet) rays are focused back at the feed horn, raising the temperature of the LNB (Low Noise Block) down converter unit, causing undesired noise or interference in the transmitted picture and accelerating the breakdown of the components. In light colored fiberglass antennas or solid metal antennas from which the paint has peeled off, prolonged heat and UV exposure may cause melting of the feed horn.

To combat these weather-related problems, the satellite antenna industry is encouraging antenna owners to use satellite dish covers. Some satellite dish covers are made from slick cloth-like material with the installed cover defining a somewhat vertical surface to help rain, snow, hail and/or various debris, such as leaves, pine needles, bird droppings and the like, slide off the cover. The cover material passes satellite signals through with virtually no signal attenuation and allows focusing of the same via the feed horn. The cloth-like cover is normally stretched on the front signal-receiving face while being attached to the back of the satellite dish via a drawstring arrangement or the like.

A tightly stretched satellite dish cover made of weatherproof cloth-like material reflects the sun's energy away from the satellite dish while maintaining the antenna at a fraction of the cost of purchasing a new satellite antenna. Unfortunately, this type of cloth-like arrangement deteriorates over time and leads to sagging of the dish cover in certain areas, which affects signal reception quality.

Some satellite covers incorporate corporate logos, OEM (Original Equipment Manufacturer) labels or private labeling from mass distributors. Some flat planar-array antennas eliminate covers entirely by printing text and/or graphics directly on the signal-receiving face of the antenna. Other satellite antennas use the signal-receiving face for application of decals, labels, 35 mm film strips and/or the like. None of the satellite antennas use covers of substantially rigid configuration that can securely snap around the entire signal-receiving perimeter of the antenna and permit transmission of satellite signals. Such satellite antenna covers would be well suited for decorative and advertising use as well as for mass-manufacturing at a reasonable cost to the user.

### SUMMARY

Exemplary embodiments disclosed herein are generally directed to a satellite antenna cover.

In accordance with one aspect of the invention, the satellite antenna cover comprises a substantially concave surface configured to permit the reception and transmission of satellite communication signals, a curved outer rim emanating from the substantially concave surface, and at least one secure antenna attachment member integrally formed on the curved outer rim. The integrally formed antenna attachment member comprises a body configured substantially as a raised bridge, and at least one elongated and resilient tab extending away from the raised bridge-like body.

In accordance with another aspect of the invention, the satellite antenna cover comprises a substantially concave body configured to permit the reception and transmission of satellite communication signals. The concave body has a front surface and a rear surface. The cover also comprises a curved outer lip emanating from the concave body. The curved outer lip provides a raised border for the rear surface of the concave body. The curved outer lip is configured to frictionally wrap around the entire outer rim of an associated satellite antenna dish.

In accordance with yet another aspect of the invention, the satellite antenna cover comprises a substantially concave body configured to permit the reception and transmission of satellite communication signals. The concave body has a front surface and a rear surface. The cover also comprises a curved outer lip emanating from the concave body. The curved outer lip provides a raised border for the rear surface of the concave body. The curved outer lip is configured to snap onto the entire outer rim of an associated satellite antenna dish. The snapped on outer lip is sufficiently tensioned to prevent removal of the concave body without the use of tools.

These and other aspects of the invention will become apparent from a review of the accompanying drawings and the following detailed description of the invention.

### BRIEF DESCRIPTION OF THE DRAWINGS

The present invention is generally shown by way of reference to the accompanying drawings in which:

FIG. 1 is a perspective view of a satellite dish antenna equipped with a dish cover constructed in accordance with an exemplary embodiment of the present invention;

FIG. 2 is a side elevational view of the satellite dish antenna and dish cover of FIG. 1;

FIG. 3 is a back elevational view of a satellite dish antenna equipped with a dish cover constructed in accordance with another exemplary embodiment of the present invention;

FIG. 4 is a cross-sectional view taken along section line 4-4 of FIG. 3;

FIG. 5 is a cross-sectional view of a satellite antenna dish equipped with a dish cover constructed in accordance with yet another exemplary embodiment of the present invention;

FIG. 6 is a cross-sectional view of a satellite antenna dish equipped with a dish cover constructed in accordance with still another exemplary embodiment of the present invention; and

FIG. 7 is a partial perspective view of a satellite antenna dish equipped with a dish cover constructed in accordance with an alternative exemplary embodiment of the present invention.

### DETAILED DESCRIPTION

The detailed description set forth below in connection with the appended drawings is intended as a description of exemplary embodiments and is not intended to represent the only forms in which the exemplary embodiments may be constructed and/or utilized. The description sets forth the functions and the sequence of steps for constructing and operating the exemplary embodiments in connection with the illustrated embodiments. However, it is to be understood that the same or equivalent functions and sequences may be accomplished by different embodiments that are also intended to be encompassed within the spirit and scope of the invention.

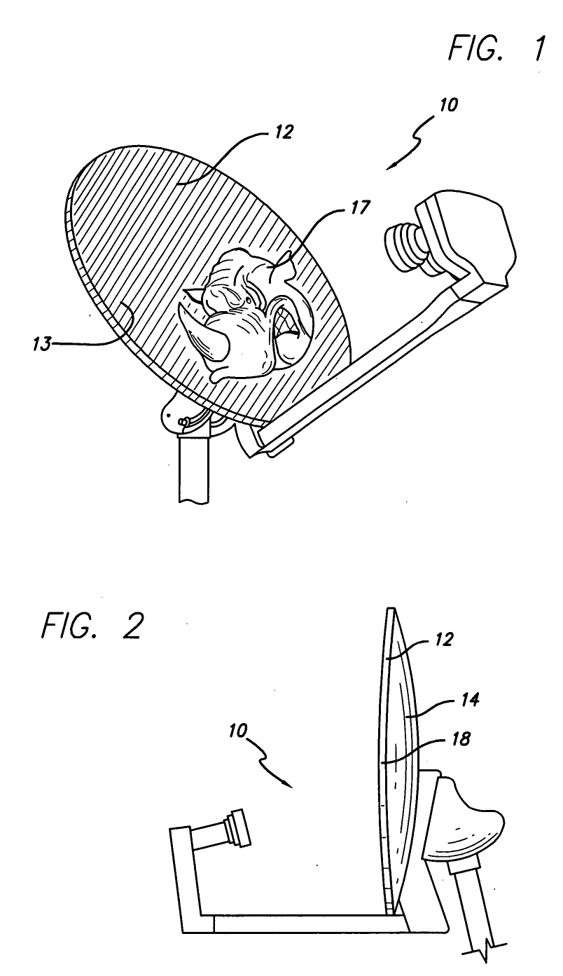

Some embodiments of the invention will be described in detail with reference to the related drawings of FIGS. 1-7. Additional embodiments, features and/or advantages of the invention will become apparent from the ensuing description or may be learned by practicing the invention. In the figures, the drawings are not to scale with like numerals referring to like features throughout both the drawings and the description.

FIG. 1 is a perspective view of a satellite dish antenna 10 equipped with a dish cover 12 in accordance with an exemplary embodiment of the present invention. Dish cover 12 shrouds the entire front signal-receiving face of antenna dish 14 (FIG. 2) with the outer surface of the signal-receiving face being of a generally concave configuration, as generally shown in FIG. 1. Dish cover 12 may be made from generally rigid weather-proof material which does not inhibit transmission of satellite communication signals and avoids the sagging problems encountered in prior art arrangements.

For example, dish cover 12 may be manufactured from durable and generally rigid plastic adapted to permit transmission of satellite communication signals to/from antenna dish 14 (FIG. 2) and effectively protect the signal-receiving face of antenna dish 14 from damaging UV radiation by the sun, inclement weather and/or various debris such as vegetation, bird droppings and the like, i.e. it is generally waterproof, cold crack resistant, high heat resistant, tear resistant and the like. In accordance with the general principles of the present invention, the term “plastic” is generally defined herein as any of various organic compounds produced by polymerization, and capable of being molded, extruded, and/or cast into various shapes.

Dish cover 12 (FIGS. 1-2) conforms substantially to the outer contours of the generally concave signal-receiving face of antenna dish 14. Dish cover 12 is provided with a generally curved outer lip 18 (FIG. 2) which frictionally wraps around the outer rim of antenna dish 14. Dish cover 12 is adapted to snap on antenna dish 14 with outer lip 18 providing secure snap fit attachment for dish cover 12 around the entire signal-receiving perimeter of antenna dish 14.

The “snap-on” dish cover 12 may be configured for removal by the user without the use of tools. Alternatively, the snap fit attachment provided by outer lip 18 may be sufficiently tensioned to prevent removal by the user without the use of tools. The need for complicated dish cover attachment setups involving cables, ties and the like, as practiced in prior art devices, is avoided.

Once installed over antenna dish 14, dish cover 12 provides a generally rigid concave outer surface 13 (FIG. 1) suitable for decorative and/or advertising use. For example, outer surface 13 may include a sports team logo 17, as generally illustrated in FIG. 1. Other usage of outer surface 13 may include applying text and/or graphics in the form of decals, labels, stickers and the like using a variety of processes such as screen printing, silk-screen printing and the like. Applied text and/or graphics may depict political or humorous messages, slogans, product advertising and/or the like. Outer lip 18 (FIG. 2) is integrally formed on rigid outer surface 13 (FIG. 1).

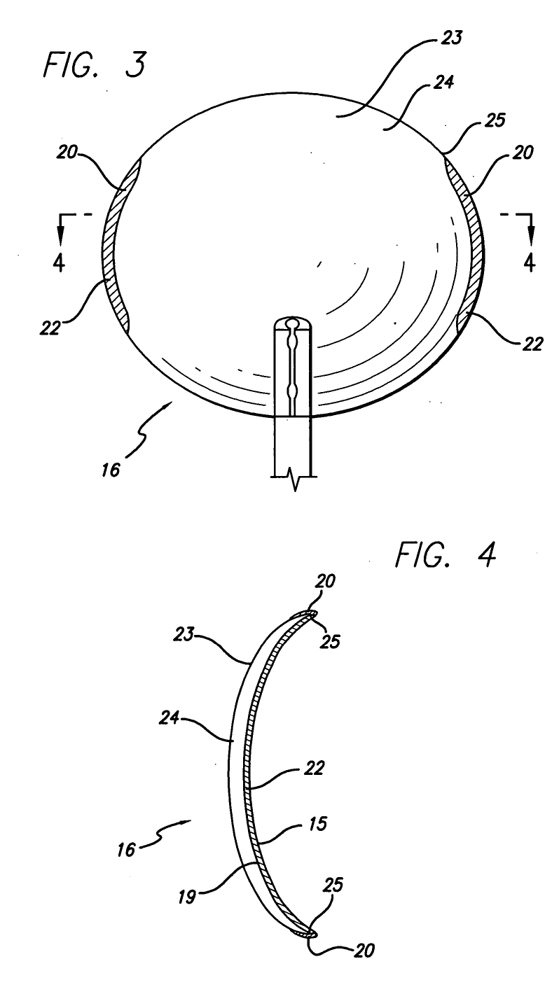

FIG. 3 is a back elevational view of a satellite dish antenna 16 equipped with a dish cover 22 in accordance with another exemplary embodiment of the present invention. As generally depicted in FIG. 4, dish cover 22 conforms substantially to the outer contours of a generally concave signal-receiving face 19 of antenna dish 24. Dish cover 22 includes generally curved outer flaps 20 (FIGS. 3-4) adapted to securely grip portions of outer rim 25 and back surface 23 of antenna dish 24, as generally shown in FIG. 4. Dish cover 22 is adapted to snap on antenna dish 24 with outer flaps 20 providing secure snap fit attachment for dish cover 22 around the entire signal-receiving perimeter of antenna dish 24.

Dish cover 22 shrouds the entire signal-receiving face 19 of antenna dish 24 while permitting transmission of satellite communication signals to/from antenna dish 24. Dish cover 22 may be constructed from generally rigid weather-proof plastic which avoids the sagging problems encountered in prior art devices. The plastic material effectively protects signal-receiving face 19 from damaging UV radiation by the sun, inclement weather and/or various debris such as vegetation, bird droppings and the like, i.e. it is generally waterproof, cold crack resistant, high heat resistant, tear resistant and the like.

Once installed over antenna dish 24, dish cover 22 provides a generally rigid concave outer surface 15 (FIG. 4) suitable for decorative and/or advertising use. Outer flaps 20 are integrally formed on rigid outer surface 15.

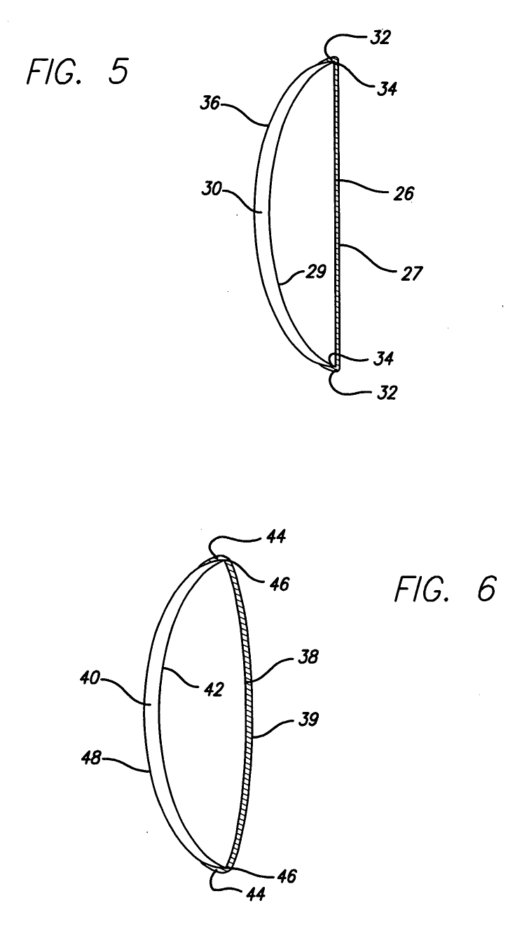

FIG. 5 is a cross-sectional view of a satellite antenna dish 30 equipped with a dish cover 26 in accordance with yet another exemplary embodiment of the present invention. Dish cover 26 is of a substantially flat configuration relative to the outer contours of a generally concave signal-receiving face 29 of antenna dish 30. Dish cover 26 includes generally curved outer flaps 32 adapted to securely grip portions of outer rim 34 and back surface 36 of antenna dish 30, as generally shown in FIG. 5. Dish cover 26 is adapted to snap on antenna dish 30 with outer flaps 32 providing secure snap fit attachment for dish cover 26 around the entire signal-receiving perimeter of antenna dish 30.

Dish cover 26 shrouds the entire signal-receiving face 29 of antenna dish 30 while permitting transmission of satellite communication signals to/from antenna dish 30. Dish cover 26 may be constructed from generally rigid weather-proof plastic which avoids the sagging problems encountered in prior art devices. The plastic material effectively protects signal-receiving face 29 from damaging UV radiation by the sun, inclement weather and/or various debris such as vegetation, bird droppings and the like, i.e. it is generally waterproof, cold crack resistant, high heat resistant, tear resistant and the like.

Once installed over antenna dish 30, dish cover 26 provides a generally rigid flat outer surface 27 (FIG. 5) suitable for decorative and/or advertising use. Outer flaps 32 are integrally formed on rigid outer surface 27.

FIG. 6 is a cross-sectional view of a satellite antenna dish 40 equipped with a dish cover 38 in accordance with still another exemplary embodiment of the present invention. Dish cover 38 is of a substantially convex configuration relative to the outer contours of a generally concave signal-receiving face 42 of antenna dish 40. Dish cover 38 includes generally curved outer flaps 44 adapted to securely grip portions of outer rim 46 and back surface 48 of antenna dish 40, as generally shown in FIG. 6. Dish cover 38 is adapted to snap on antenna dish 40 with outer flaps 44 providing secure snap fit attachment for dish cover 38 around the entire signal-receiving perimeter of antenna dish 40.

Dish cover 38 shrouds the entire signal-receiving face 42 of antenna dish 40 while permitting transmission of satellite communication signals to/from antenna dish 40. Dish cover 38 may be constructed from generally rigid weather-proof plastic which avoids the sagging problems encountered in prior art devices. The plastic material effectively protects signal-receiving face 42 from damaging UV radiation by the sun, inclement weather and/or various debris such as vegetation, bird droppings and the like, i.e. it is generally waterproof, cold crack resistant, high heat resistant, tear resistant and the like.

Once installed over antenna dish 40, dish cover 38 provides a generally rigid convex outer surface 39 (FIG. 6) suitable for decorative and/or advertising use. Outer flaps 44 are integrally formed on rigid outer surface 39.

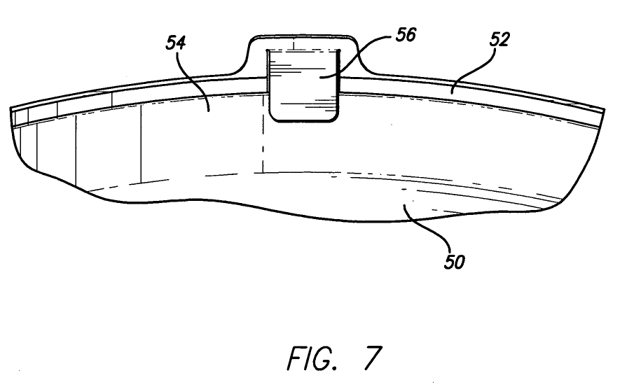

FIG. 7 is a partial perspective view of a satellite antenna dish 50 equipped with a dish cover 52 in accordance with an alternative exemplary embodiment of the present invention. Dish cover 52 is adapted to shroud the entire front signal-receiving face of antenna dish 50 which is generally concave. Dish cover 52 permits transmission of satellite communication signals to/from antenna dish 50. The concave signal-receiving face of antenna dish 50 terminates with an extended and generally curved outer rim 54.

Dish cover 52 may be made from generally rigid weather-proof material, such as plastic, which does not inhibit transmission of satellite communication signals and protects the signal-receiving face of satellite dish 50 from damaging UV radiation by the sun, inclement weather and/or various debris such as vegetation, bird droppings and the like. This type of dish cover material is generally waterproof, cold crack resistant, high heat resistant, tear resistant and the like.

Dish cover 52 conforms substantially to the outer contours of the generally concave signal-receiving face and extended outer rim 54 of antenna dish 50. Dish cover 52 is provided with a plurality of generally elongated spring-like terminal tabs, such as tab 56, adapted to snap over outer rim 54 of antenna dish 50, as generally depicted in FIG. 7. Dish cover 52 is configured to snap on antenna dish 50 via the terminal tabs, such as tab 56, providing a secure snap fit attachment for dish cover 52 around the entire signal-receiving perimeter of antenna dish 50. The “snap-on” dish cover 52 may be easily removed by the user without the use of any tools. Once installed over antenna dish 50, dish cover 52 provides a generally rigid concave outer surface suitable for decorative and/or advertising use.

A person skilled in the art would readily recognize that various other satellite cover attachment arrangements may be utilized, provided such other attachment arrangements do not depart from the intended purpose of the present invention.

The satellite antenna cover of the present invention is not limited for use on satellite antennas of the concave signal-receiving (reflective) face type. For example, each one of the exemplary dish cover embodiments, generally shown and described hereinabove in reference to FIGS. 5 and 6, may be readily modified for use on satellite antennas of the flat planar-array type. For example, one such flat planar-array antenna that would be well suited for use with the satellite antenna cover of the present invention incorporates a plurality of receivers on its face adapted to collect signals sent by one or more satellites. The collected signals are transmitted via appropriate circuitry to an amplifier (LNB) which is integrated at the back of the antenna.

Other components and/or configurations may be utilized, provided such other components and/or configurations remain within the intended scope of the present invention. Other materials may be used to construct the satellite dish cover of the present invention, provided such other materials do not deviate from the intended scope and spirit of the present invention. The generally rigid outer surface of the signal-receiving face of the satellite dish cover of the present invention offers users convenient medium for decorative and/or advertising use.

A person skilled in the art would appreciate that exemplary embodiments described hereinabove are merely illustrative of the general principles of the present invention. Other modifications or variations may be employed that are within the scope of the invention. Thus, by way of example, but not of limitation, alternative configurations may be utilized in accordance with the teachings herein. Accordingly, the drawings and description are illustrative and not meant to be a limitation thereof.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Thus, it is intended that the invention cover all embodiments and variations thereof as long as such embodiments and variations come within the scope of the appended claims and their equivalents.

What is claimed:

1. A satellite antenna cover, comprising:
a substantially concave surface configured to permit the reception and transmission of satellite communication signals;
a curved outer rim emanating from said substantially concave surface; and
at least one secure antenna attachment member integrally formed on said curved outer rim, said at least one integrally formed antenna attachment member comprising:
a body configured substantially as a raised bridge; and
at least one elongated and resilient tab extending away from said raised bridge-like body.

2. The satellite antenna cover of claim 1, wherein said substantially concave surface is further configured for decorative and advertising use.

3. The satellite antenna cover of claim 1, wherein said substantially concave surface is substantially weather-proof.

4. The satellite antenna cover of claim 1, wherein said substantially concave surface is substantially tear-resistant.

5. The satellite antenna cover of claim 1, wherein said substantially concave surface is substantially rigid.

6. The satellite antenna cover of claim 1, wherein said substantially concave surface is made of plastic material.

7. The satellite antenna cover of claim 1, wherein said substantially concave surface is substantially crack-resistant.

8. The satellite antenna cover of claim 1, wherein said substantially concave surface is substantially heat-resistant.

9. The satellite antenna cover of claim 1, wherein said substantially concave surface is further configured to shroud the entire signal-receiving face of an associated satellite antenna dish.

10. The satellite antenna cover of claim 1, wherein said at least one elongated and resilient tab is configured to provide secure attachment for said outer rim of said substantially concave surface around the entire signal-receiving perimeter of an associated satellite antenna dish.

11. A satellite antenna cover, comprising:
a substantially concave body configured to permit the reception and transmission of satellite communication signals, said substantially concave body having a front surface and a rear surface; and
a curved outer lip emanating from said substantially concave body, said curved outer lip providing a raised border for said rear surface of said substantially concave body, said curved outer lip being configured to frictionally wrap around the entire outer rim of an associated satellite antenna dish.

12. A satellite antenna cover, comprising:
a substantially concave body configured to permit the reception and transmission of satellite communication signals, said substantially concave body having a front surface and a rear surface; and
a curved outer lip emanating from said substantially concave body, said curved outer lip providing a raised border for said rear surface of said substantially concave body, said curved outer lip being configured to securely snap onto the entire outer rim of an associated satellite antenna dish, said snapped on outer lip being sufficiently tensioned to prevent removal of said substantially concave body without the use of tools.

13. The satellite antenna cover of claim 11, wherein said substantially concave body is further configured for decorative and advertising use.

14. The satellite antenna cover of claim 11, wherein said substantially concave body is substantially weather-proof.

15. The satellite antenna cover of claim 11, wherein said substantially concave body is substantially tear-resistant.

16. The satellite antenna cover of claim 11, wherein said substantially concave body is substantially rigid.

17. The satellite antenna cover of claim 11, wherein said substantially concave body is made of plastic material.

18. The satellite antenna cover of claim 11, wherein said substantially concave body is substantially crack-resistant.

19. The satellite antenna cover of claim 11, wherein said substantially concave body is substantially heat-resistant.

20. The satellite antenna cover of claim 11, wherein said substantially concave body is further configured to shroud the entire signal-receiving face of said associated satellite antenna dish.

21. The satellite antenna cover of claim 12, wherein said substantially concave body is further configured for decorative and advertising use.

22. The satellite antenna cover of claim 12, wherein said substantially concave body is substantially weather-proof.

23. The satellite antenna cover of claim 12, wherein said substantially concave body is substantially tear-resistant.

24. The satellite antenna cover of claim 12, wherein said substantially concave body is substantially rigid.

25. The satellite antenna cover of claim 12, wherein said substantially concave body is made of plastic material.

26. The satellite antenna cover of claim 12, wherein said substantially concave body is substantially crack-resistant.

27. The satellite antenna cover of claim 12, wherein said substantially concave body is substantially heat-resistant.

28. The satellite antenna cover of claim 12, wherein said substantially concave body is further configured to shroud the entire signal-receiving face of said associated satellite antenna dish.
